(19) United States
(12) Patent Application Publication
(10) Pub. No.: US 2005/0012869 A1
(43) Pub. Date: Jan. 20, 2005

(54) Video receiving tuner

(76) Inventor: Toshifumi Akiyama, Kashihara-Shi (JP)

Correspondence Address: BIRCH STEWART KOLASCH & BIRCH, PO BOX 747, FALLS CHURCH, VA, 22040-0747, US

(21) Appl. No.: 10/885,772

(22) Filed: Jul. 8, 2004

(30) Foreign Application Priority Data
Jul. 17, 2003 (JP) 2003-198221

(51) Int. Cl. H04N 7/173; H04N 7/16; H04N 5/455; H04N 11/04

(52) U.S. Cl. 348/731; 725/131; 725/139; 725/151; 725/127; 375/240.25

(57) ABSTRACT

A video receiving tuner relating to the present invention comprises an input terminal for receiving video reception signals that are digitally modulated, a front-end block for amplifying the video reception signals fed thereto from the input terminal and selecting a signal of one channel as a selection signal from among the amplified video reception signals, a digital demodulation circuit block for demodulating the selection signal into a digital signal, a re-modulation circuit block for modulating a carrier wave having a predetermined frequency by the digital signal so as to produce a re-modulation signal, a transmission circuit block for processing the re-modulation signal fed thereto from the re-modulation circuit and outputting a resultant signal as a radio signal, an antenna for transmitting the radio signal, and a casing for enclosing the front-end block, the digital demodulation circuit block, the re-modulation circuit block, and the transmission circuit block.

### BACKGROUND OF THE INVENTION

This non-provisional application claims priority under 35 U.S.C. § 119(a) on Patent Application No. 2003-19822 filed in Japan on Jul. 17, 2003, the entire contents of which are hereby incorporated by reference.

### FIELD OF THE INVENTION

The present invention relates to a video receiving tuner that receives video signals digitally modulated in such systems as satellite broadcasting, cable television broadcasting, and terrestrial broadcasting, and that selects channels, demodulates a signal of the selected channel, and transmits the demodulated signal to a television receiver. The present invention particularly relates to a video receiving tuner that can be made in compact size and designed as to allow the television receiver to be relocated easily or to be viewed while the television receiver is being moved.

### DESCRIPTION OF THE PRIOR ART

In recent years, a digital broadcasting system has been widely used in cable television (CATV) broadcasting, satellite broadcasting, and terrestrial broadcasting. Usually, for example, when these digital broadcastings are viewed in a collective housing such as apartments and condominiums or in a detached house, an antenna terminal from which video reception signals of the digital broadcastings are fed out is installed in a room where broadcasting programs are viewed. The antenna terminal is fed with the video reception signals transmitted from a receiving antenna installed on a roof of a building or from an external CATV system through a transmission line such as a coaxial cable.

Then, a video reception signal of a desired channel is selected and demodulated by the video receiving tuner connected to this antenna terminal. The demodulated video reception signal is outputted from a television receiver which is connected to the video receiving tuner as video images and audio sounds. FIG. 10 is a block diagram showing an electrical configuration of the conventional video receiving tuner as explained earlier. In FIG. 10, reference numeral 1 represents a video receiving tuner. The video receiving tuner 1 comprises an F-type plug (input terminal) 2, a front-end block 3, and a digital demodulation circuit block 4. The front-end block 3 and the digital demodulation circuit block 4 are enclosed in a single casing. Moreover, the F-type plug 2 is fitted to a surface of the casing.

The F-type plug is connected to an antenna terminal (not illustrated) provided on a wall or the like in a viewing room by way of a transmission line such as a coaxial cable. The video reception signals are inputted through the F-type plug 2. The inputted video reception signals are amplified by the front-end block 3 that is connected to the F-type plug 2 internally. A preset channel is selected from among the amplified video reception signals. Furthermore, the video reception signal of the selected channel is demodulated into a baseband digital signal (stream data) by the digital demodulation circuit block 4.

During this process, the digital signal obtained through the demodulation performed by the digital demodulation circuit block 4 is outputted as a parallel digital signal formed of 10 to 16 bits depending on a type of the video reception signal. In the case of the CATV broadcasting, for example, an IF (intermediate frequency) signal is digitized by a 10-bit A/D converter. In the case of the digital satellite broadcasting (digital BS broadcasting), this will be a 12- to 16-bit digital signal, because two individual outputs, each corresponding to each of the I/Q outputs, are digitized by 6- to 8-bit A/D converters respectively. Thereafter, the digital signal is fed to a television receiver through signal lines such as a multi-conductor cable and connectors. Then, video and audio information based on the digital signal supplied to the television receiver is outputted therefrom.

However, if a mobile or a movable type television receiver is used, it is not feasible to use and route a cable or the like as the lines through which the digital signal is supplied thereto. To solve this problem, there is a way in which a wireless transmitting/receiving device is connected to the video receiving tuner 1 so that the wireless transmitting/receiving device transmits the digital signal to the television receiver by radio.

Furthermore, Japanese Patent Application Laid-Open No. 2002-374260 discloses an information relay device which, by connecting an indoor terminal device to an outside network through a CATV network, is used for relaying transmission and reception data that is exchanged therebetween. The information relay device incorporates, in a single casing, a wireless relaying device and a cable modem for interconnecting between the wireless relaying device and the CATV network. The wireless relaying device is provided with an antenna for relaying and transmitting the data transmitted by radio from the terminal device to the outside network and, at the same time, for transmitting the data sent thereto from the outside network via the CATV network to the terminal device by radio.

Furthermore, Japanese Patent Application Laid-Open No. H5-300070 discloses an information transmission system in which information is transmitted to a mobile station through a radio channel. In this system, there is provided a relay station that has a transmission information storage means for receiving and storing the information received through the radio channel, and a transmission means for transmitting by radio the information stored in transmission information storage means to the mobile station installed in a moving body at a passing point of the moving body on its track. The mobile station is equipped with an output means for restoring the information transmitted by radio from the transmission means and outputting the restored information in the moving body.

However, a conventional video receiving tuner such as the one shown in FIG. 10 requires a number of signal lines corresponding to a number of bits constituting the digital signal that is outputted in parallel as described above. Even if a miniaturization of the video receiving tuner is promoted by using integrated circuits, there is a problem in which wiring and routing of these signal lines constitute restrictions on downsizing an area occupied by the video receiving tuner. In addition, the front-end block 3 and the digital demodulation circuit block 4 shown in FIG. 10 are usually arranged on a main circuit board (not shown) of the video receiving tuner 1. For this reason, connectors, each having a plurality of connector pins, are required on the main circuit board and the casing so as to lead out the digital signal that is fed out from the digital demodulation circuit block 4 via a dozen or so signal lines. Narrowly-pitched connectors can be used in an attempt to solve this problem. However, the restrictions for miniaturization are still unsolved. In addition, these connectors and signal lines also become the factors responsible for pushing up the costs.

When the digital signal is transmitted by radio by connecting the wireless transmitting/receiving device to the video receiving tuner 1 to cope with the mobile-type or the movable-type television receiver, an area occupied by this separately provided wireless transmitting/receiving device is additionally required, and such connecting items as a cable and a connector on the side of the video receiving tuner 1 are also required. This also makes it difficult to miniaturize the video receiving tuner 1.

According to the conventional technology disclosed in Japanese Patent Application Laid-Open No. 2002-374260, the information relay device by which the indoor terminal device and the outside network are connected together through the CATV network can be easily installed. However, because this information relay device is not compatible with the video reception signals used in such systems as the satellite broadcasting, the terrestrial broadcasting, and the like, a separately arranged video receiving tuner should be installed so as to demodulate the video reception signals transmitted by these systems.

According to the conventional technology disclosed in Japanese Patent Application Laid-Open No. H5-300070, even when the moving body is moving on a track where the moving body is unable to receive directly an incoming wave modulated with transmission information, the moving body is able to receive the transmission information at a passing point on its track. In this case, however, because the transmission information is such that is stored once and transmitted later, a delay is caused in receiving the information. Moreover, a structure of a system like this becomes complicated, because a device for storing the transmission information and a controller for controlling the transmission of the stored transmission information are required.

### SUMMARY OF THE INVENTION

An object of the present invention is, in light of the aforementioned inconveniences, to provide a video receiving tuner that can be made small in size and in installation area, and is capable of supplying the selected video images even to mobile or movable television receivers without delay and without arranging an additional radio communication device.

To achieve the above object, according to one aspect of the invention, a video receiving tuner relating to the present invention comprises an input terminal for receiving video reception signals that are digitally modulated, a front-end block for amplifying the video reception signals fed thereto from the input terminal and selecting a signal of one channel as a selection signal from among the amplified video reception signals, a digital demodulation circuit block for demodulating the selection signal into a digital signal, a re-modulation circuit block for modulating a carrier wave having a predetermined frequency by the digital signal so as to produce a re-modulation signal, a transmission circuit block for processing the re-modulation signal fed thereto from the re-modulation circuit and outputting a resultant signal as a radio signal, an antenna for transmitting the radio signal, and a casing for enclosing the front-end block, the digital demodulation circuit block, the re-modulation circuit block, and the transmission circuit block.

With this arrangement, an additional radio transmitting/receiving device for transmitting the digital signal to the television receiver will not be required. Furthermore, because the digital signal is transmitted by radio and the wiring and routing of the lines required for the digital signal are minimized, it is possible to miniaturize the video receiving tuner that is compatible with the mobile and movable television receivers.

As another embodiment, a video receiving tuner comprises an input terminal for receiving video reception signals that are digitally modulated; a tuner block connected to the input terminal, comprising a front-end block having an amplification block for amplifying the video reception signals fed thereto from the input terminal and a channel selection block for selecting, in accordance with a channel control signal obtained by demodulating a control signal which is externally given for selecting a desired channel, a signal of one channel as a selection signal from among the amplified video reception signals, a digital demodulation circuit block for demodulating the selection signal into a digital signal, a re-modulation/demodulation circuit block for modulating a carrier wave having a predetermined frequency by the digital signal so as to produce a re-modulation signal, and demodulating the control signal into the channel control signal so as to be fed to the channel selection block, and a transmission/reception circuit block for processing the re-modulation signal fed thereto from the re-modulation circuit, outputting a resultant signal as a radio signal, and outputting the control signal fed thereto to the re-modulation/demodulation circuit block; an antenna for transmitting the radio signal and receiving the control signal; and a casing for enclosing the tuner block.

With this arrangement, it is possible to miniaturize the video receiving tuner that is capable of selecting a channel by radio from among channels of the video reception signals according to the channel selection on a mobile or a movable television receiver, and transmit thereto a digital signal of the selected channel.

According to the present invention, a plurality of tuner blocks are enclosed in the casing. With this arrangement, it is possible to realize a compact video receiving tuner capable of selecting a plurality of channels from among channels of the video reception signals according to the control signals transmitted by radio from a plurality of mobile or movable television receivers, and capable of transmitting thereto the digital signals of the plurality of channels simultaneously.

According to the present invention, a modulation system of the selection signal selected by at least one tuner block is different from a modulation system of the selection signal selected by another tuner block. This makes it possible for a single video reception tuner to demodulate the video reception signals of a plurality of channels each of which is modulated in a different modulation system.

According to the present invention, a modulation system used for producing the re-modulation signal is different from a modulation system used for producing the selection signal. Therefore, it is possible to prevent interference between the re-transmitted radio signal and the broadcast video reception signals from occurring.

According to the present invention, a frequency band of the carrier wave used for the re-modulation signal is a 2.4 GHz frequency band or a 5 GHz frequency band. For this reason, it is possible to use a very compact antenna that is capable of transmitting and receiving the re-modulated radio signal efficiently, and miniaturize the video receiving tuner further.

According to the present invention, the digital demodulation circuit block and the re-modulation/demodulation circuit block are formed by a single integrated circuit. Therefore, it is possible to miniaturize the video receiving tuner further.

According to the present invention, a channel of the carrier wave of the predetermined frequency used by the re-modulation/demodulation circuit block to be modulated with the digital signal is associated in advance with the desired channel to be selected by the front-end block. Therefore, it is possible to prevent interferences between a plurality of radio signals even when a plurality of video receiving tuners are installed.

According to the present invention, the video receiving tuner further comprises a power supply unit for supplying power thereto, and the power supply unit is housed in the casing. As a result, it is possible to realize a compact video receiving tuner that incorporates a power supply, transmits by radio the digital signal which has been obtained through the channel selection and demodulation, and selects a channel by radio from among the video reception signals so as to cope with the mobile and movable television receivers.

According to the present invention, the input terminal is provided on one surface of the casing so that, when said one surface of the casing is brought into contact with a plane surface on which an external antenna terminal for feeding the video reception signals is provided, a good fit between the external antenna terminal and the input terminal is insured so as to maintain said one surface of the casing in contact with the plane surface. As a result of this, it is possible to eliminate the antenna cable which is otherwise required for connecting between the input terminal and the antenna terminal for transmitting the video reception signals.

According to the present invention, holding means is provided for holding the casing on the plane surface while a good fit is maintained between the external antenna terminal and the input terminal. For this reason, it is possible to realize a video receiving tuner that can be used while the tuner is suspended on a plane such as a wall surface of a room in which the external antenna terminal is provided.

### DESCRIPTION OF THE DRAWINGS

This and other objects and features of the present invention will become clear from the following description, taken in conjunction with the preferred embodiments with reference to the accompanying drawings in which:

FIG. 1 is a block diagram showing an electrical configuration of a video receiving tuner of a first embodiment of the invention;

FIG. 2 is a block diagram showing an electrical configuration of a video receiving tuner of a second embodiment of the invention;

FIG. 3 is a block diagram showing an electrical configuration of a video receiving tuner of a third embodiment of the invention;

FIG. 4 is a block diagram showing an electrical configuration of a video receiving tuner of a fourth embodiment of the invention;

FIG. 5 is a block diagram showing a specific example of the video receiving tuner of the first embodiment shown in FIG. 1;

FIG. 6 is a block diagram showing another specific example of the video receiving tuner of the first embodiment shown in FIG. 1;

FIG. 7 is a block diagram showing still another specific example of the video receiving tuner of the first embodiment shown in FIG. 1;

FIG. 8 is a perspective view showing a structure of the video receiving tuner embodying the invention;

FIG. 9 is a schematic diagram showing a relative location of the video receiving tuner embodying the invention when in service; and

FIG. 10 is a block diagram showing an electrical configuration of a conventional video receiving tuner.

### DESCRIPTION OF THE PREFERRED EMBODIMENT

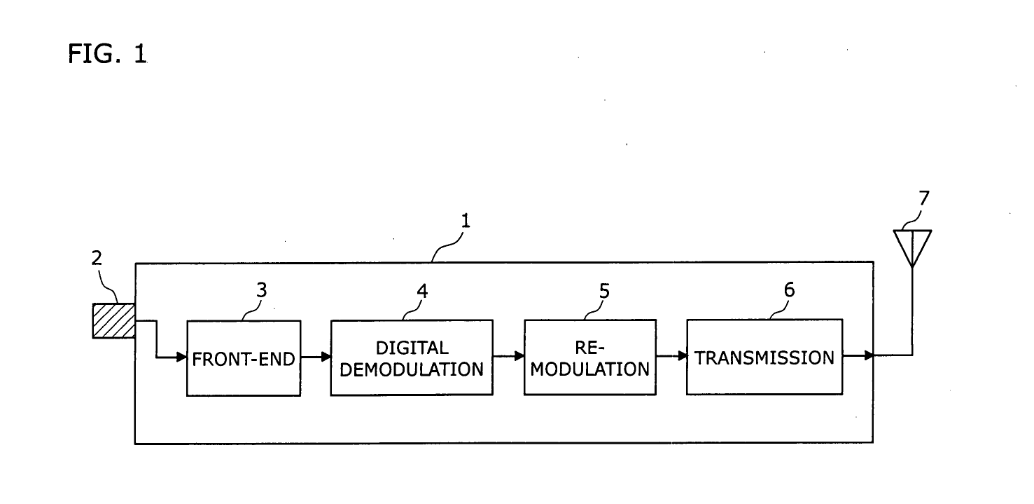

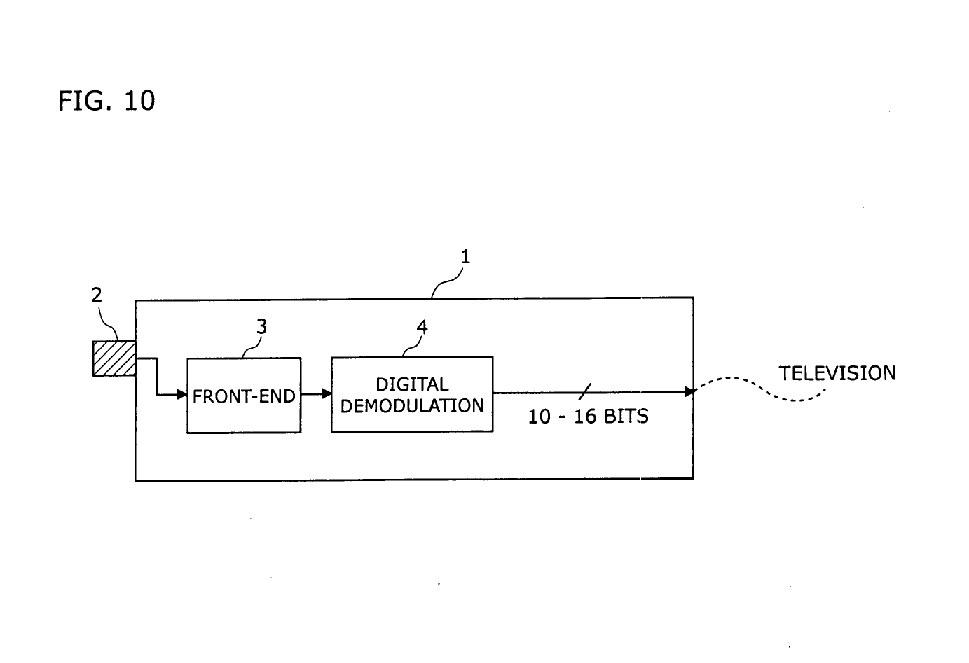

Hereinafter, embodiments of the present invention will be described with reference to the accompanying drawings. For convenience' sake, in the following descriptions, such components as are found also in the conventional example shown in FIG. 10 are identified with the same reference numerals. FIG. 1 is a block diagram showing an electrical configuration of a video receiving tuner of a first embodiment of the invention. In FIG. 1, reference numeral 1 represents a video receiving tuner. The video receiving tuner 1 comprises an F-type plug (input terminal) 2, a front-end block 3, a digital demodulation circuit block 4, a re-modulation circuit block 5, a transmission circuit block 6, and an antenna 7. The front-end block 3, the digital demodulation circuit block 4, the re-modulation circuit block 5, and the transmission circuit block 6 are housed in a single casing. Moreover, the F-type plug 2 and the antenna 7 are fitted to a surface of the casing.

As previously explained, connected to an antenna terminal arranged in a viewing room is the F-type plug 2 to which video reception signals modulated by such modulation systems as QPSK (Quadrature Phase Shift Keying), QAM (Quadrature Amplitude Modulation), and OFDM (Orthogonal Frequency Division Multiplexing) are fed in. Then, the video reception signals thus fed in are amplified, and a preset channel is selected from among the amplified signals by the front-end block 3 which is connected to the F-type plug 2. Thereafter, the signal of the selected channel fed from the front-end block 3 is demodulated into a baseband digital signal (stream data) by the digital demodulation circuit block 4.

Then, the baseband digital signal thus demodulated is fed to the re-modulation circuit block 5 and re-modulated by a baseband processing IC included therein. To be specific, a carrier wave in a 2.4 GHz frequency band or a 5 GHz frequency band is modulated by the digital signal that has been previously demodulated. Thereafter, the re-modulated digital signal is transmitted by the transmission circuit block 6 through the antenna 7 as a radio signal. Here, it is possible to prevent interference between the re-modulated radio signal and the broadcast video reception signals from occurring by making the modulation system performed by the re-modulation circuit block 5 different from that used for the broadcast video reception signals.

As described above, the wiring and routing of the signal lines for the digital signal can be achieved effectively by immediately feeding the baseband digital signal obtained through the demodulation performed by the digital demodulation circuit block 4 to the re-modulation circuit block 5 provided as the subsequent stage. It is also possible to eliminate the signal lines and connectors for leading the signal to outside by transmitting the digital signal by radio, and thereby achieve a reduction in size of the video receiving tuner 1. Here, it is to be noted that, although the re-modulated frequency band is not limited to a 2.4 GHz frequency band or a 5 GHz frequency band, it is possible to use a very compact antenna that is capable of transmitting and receiving the re-modulated radio signal efficiently and miniaturize the video receiving tuner 1 further, because these frequency bands are popularly used in Japan for a wireless LAN system and are of high frequency waves.

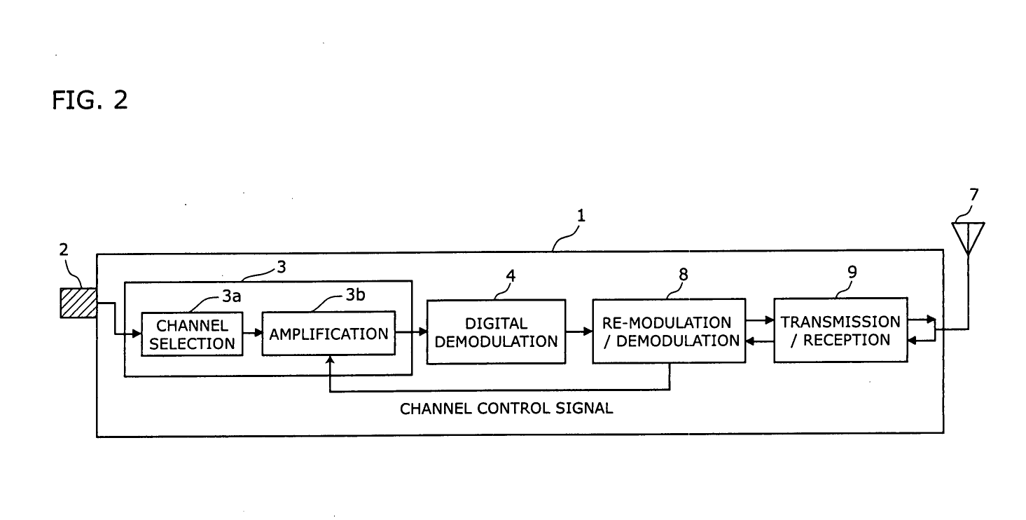

FIG. 2 is a block diagram showing an electrical configuration of a video receiving tuner of a second embodiment of the invention. In FIG. 2, such components as are found also in FIG. 1 are identified with the same reference numerals and descriptions thereof will not be repeated. A video receiving tuner 1 shown in FIG. 2 comprises an F-type plug (input terminal) 2, a front-end block 3, a digital demodulation circuit block 4, a re-modulation/demodulation circuit block 8, a transmission/reception circuit block 9, and an antenna 7. The front-end block 3, the digital demodulation circuit block 4, the re-modulation/demodulation circuit block 8, and the transmission/reception circuit block 9 are housed in a single casing.

The front-end block 3 comprises an amplification block 3a for amplifying the video reception signals fed from the F-type plug 2 and a channel selection block 3b for selecting a channel based on a channel control signal which will be described later. The signal of the channel selected by the channel selection block 3b is demodulated into a baseband digital signal (stream data) by the digital demodulation circuit block 4. Then, the demodulated baseband digital signal is fed to the re-modulation/demodulation circuit block 8 so as to be re-modulated by a baseband processing IC included therein. To be more specific, a carrier wave in a 2.4 GHz frequency band or a 5 GHz frequency band is modulated by the demodulated digital signal. Thereafter, the re-modulated digital signal is transmitted by the transmission/reception circuit block 9 through the antenna 7 as a radio signal.

Furthermore, the transmission/reception circuit block 9, through the antenna 7, receives a control signal that is modulated in an identical modulation system as the radio signal to be transmitted. This control signal is a signal transmitted from outside for selecting a desired channel by a user. The control signal, after having been received by the transmission/reception circuit block 9, is demodulated into the channel control signal by the re-modulation/demodulation circuit block 8 and fed to the channel selection block 3b of the front-end block 3. The channel selection block 3b, as explained above, selects a channel based on this demodulated channel control signal. In this way, it becomes possible to realize a compact video receiving tuner 1 capable of selecting a channel according to a signal transmitted from outside by radio. Here, the control signal for selecting a channel may be transmitted by radio from a channel selection means such as a remote control unit owned by a user or transmitted by radio through a television receiver on which images are viewed.

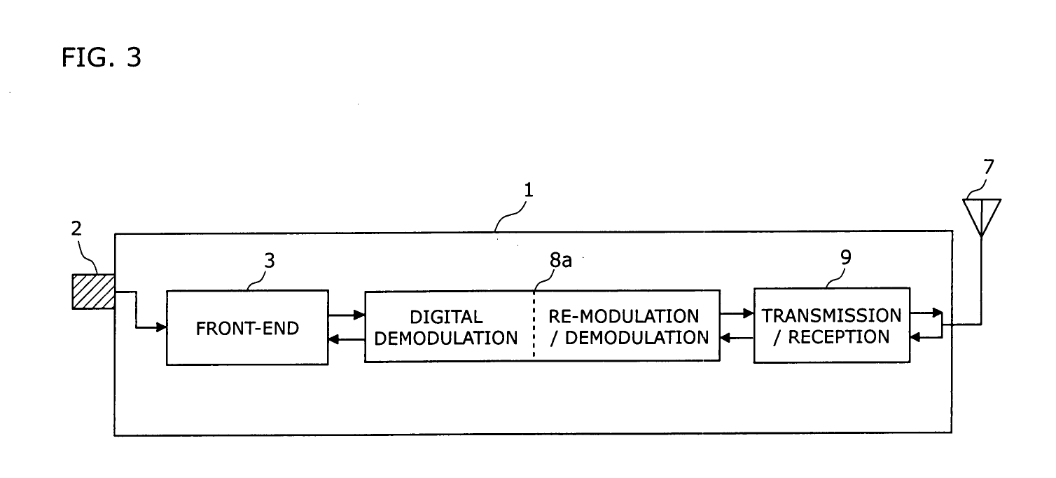

FIG. 3 is a block diagram showing an electrical configuration of a video receiving tuner of a third embodiment of the invention. In FIG. 3, such components as are found also in FIG. 2 are identified with the same reference numerals and descriptions thereof will not be repeated. A difference between a video receiving tuner 1 shown in FIG. 3 and the video receiving tuner 1 shown in FIG. 2 is that the digital demodulation circuit block 4 and the re-modulation/demodulation circuit block 8 shown in FIG. 2 are integrated into one and provided as a modulation/demodulation circuit block 8a.

The modulation/demodulation circuit block 8a is a one-chip IC having the functions of both the digital demodulation circuit block 4 and the re-modulation/demodulation circuit block 8 shown in FIG. 2. As is the case for the digital demodulation circuit block 4 and the re-modulation/demodulation circuit block 8 shown in FIG. 2, a baseband processing block for processing a baseband signal is usually formed by CMOS logic circuits. Therefore, when a baseband IC at the reception side (digital demodulation circuit block) and a baseband IC at the re-transmission side (re-modulation/demodulation circuit block) are integrated into a one-chip IC, it is possible to reduce portions common to different blocks such as a power supply circuit to one portion and, thereby, achieve miniaturization. In this way, it is possible to miniaturize the video receiving tuner 1 further by providing the modulation/demodulation circuit block 8a as a one-chip IC.

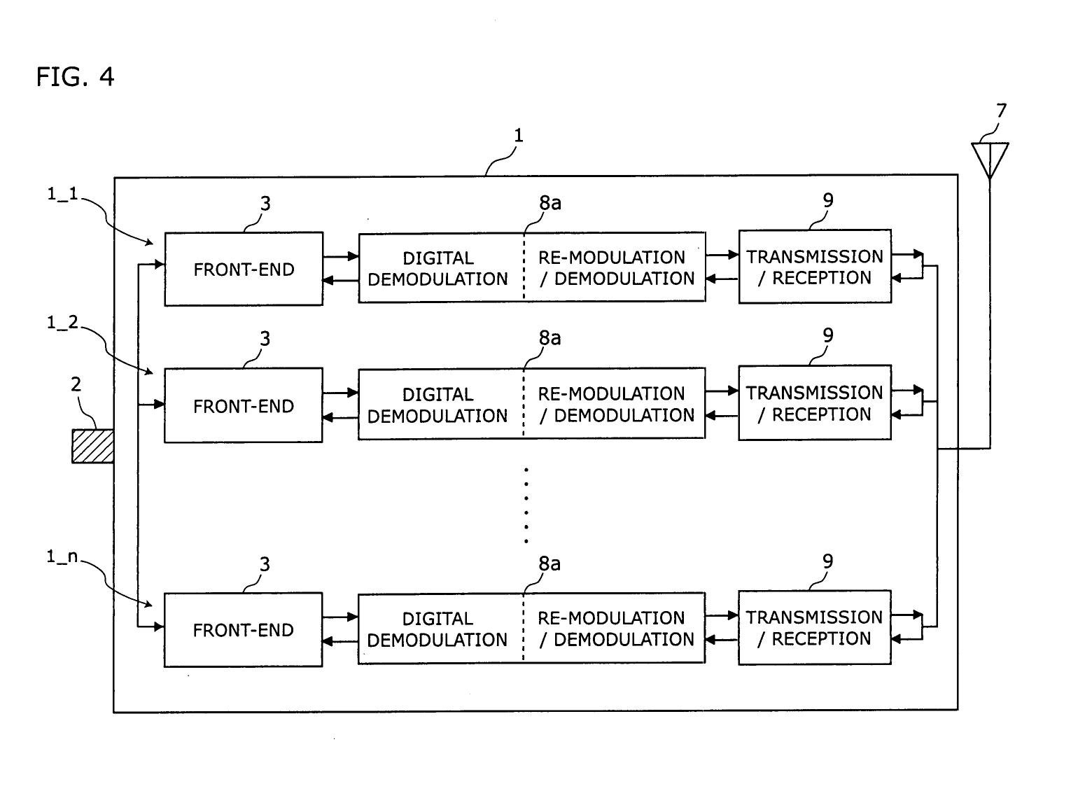

FIG. 4 is a block diagram showing an electrical configuration of a video receiving tuner of a fourth embodiment of the invention. In FIG. 4, such components as are found also in FIG. 3 are identified with the same reference numerals and descriptions thereof will not be repeated. A difference between a video receiving tuner 1 shown in FIG. 4 and the video receiving tuner 1 shown in FIG. 3 is that there are provided a plurality of front-end blocks 3, a plurality of modulation/demodulation circuit blocks 8a each of which is connected to each of the front-end blocks 3, and a plurality of transmission/reception circuit blocks 9 each of which is connected to each of the modulation/demodulation circuit blocks 8a.

The plurality of front-end blocks 3 are all connected in parallel to an F-type plug 2. Video reception signals fed to the F-type plug are amplified and a channel selection is performed by each of the front-end blocks 3. Then, each signal of the selected channel in each of the front-end blocks 3 is fed to each of the modulation/demodulation circuit blocks 8a and demodulated into a baseband digital signal (stream data) by a digital demodulation circuit block included in each of the modulation/demodulation circuit blocks 8a. The digital signal obtained as a result of the demodulation is then re-modulated into a radio signal by the re-modulation/demodulation circuit block included in the same modulation/demodulation circuit blocks 8a and transmitted by radio through a common antenna 7 from each of the transmission/reception circuit blocks 9. During this process, the channel selection in each of the front-end blocks 3 is performed in accordance with each channel control signal obtained by demodulating a control signal, which is received by each of the transmission/reception circuit blocks 9 from outside, in the re-modulation/demodulation circuit block included in each of the modulation/demodulation circuit blocks 8a.

In addition, a carrier wave used when the demodulated digital signal is re-modulated by the re-modulation/demodulation circuit block included in the re-modulation/demodulation circuit block 8a is, as described above, either in a 2.4 GHz frequency band or a 5 GHz frequency band. However, although an identical frequency band is used for all the frequency channels of the carrier waves, each of the frequency channels is different from each other for each of the modulation/demodulation circuit blocks 8a. The frequency channel is predetermined in accordance with a channel of the video reception signal selected in the front-end block 3.

With this arrangement, it is possible to re-transmit video reception signals of a plurality of channels as the digital signals of a plurality of channels simultaneously. To be more specific, the video receiving tuner 1 shown in FIG. 4 can be used as a digital broadcast relay within a small area. When one or more video receiving tuners 1 are installed at a predetermined spacing apart from each other in that relay area, it is possible to view programs of a plurality of channels of digital broadcastings on each of a plurality of mobile television receivers at the same time in such a blind spot as the inside of a building or a underground shopping complex where a direct reception of the digital broadcasting signals is not possible.

For example, the video receiving tuner 1 shown in FIG. 4 comprises a first tuner block 1_1, a second tuner block 1_2, and an nth. tuner block 1_n of which each having the front-end block 3, the modulation/demodulation circuit block 8a, and the transmission/reception circuit block 9. Here, for convenience' sake, tuner blocks existing between the second tuner block 1_2 and the nth. tuner block 1_n are ignored. For example, the front-end block 3 of the first tuner block 1_1 is preset to a reception channel CH1 of the digital broadcasting; the front-end block 3 of the second tuner block 1_2 is preset to a reception channel CH2 of the digital broadcasting; and the front-end block 3 of the nth. tuner block 1_n is preset to a reception channel CH(n) of the digital broadcasting. Furthermore, a different frequency channel within an identical frequency band is preset for each of the modulation/demodulation circuit blocks 8a which perform modulations by using a carrier wave in a 2.4 GHz frequency band or a 5 GHz frequency band. For example, the modulation/demodulation circuit block 8a of the first tuner block 1_1 is preset to a frequency channel CH(A); the modulation/demodulation circuit block 8a of the second tuner block 1_2 is preset to a frequency channel CH(B); and the modulation/demodulation circuit block 8a of the nth. tuner block 1_n is preset to a frequency channel CH(N).

This makes it possible for a plurality of users each having a mobile television receiver in the relay area to view any of the programs of the reception channels CH1 to CH(n) of the digital broadcasting by selecting a frequency channel from among the frequency channels CH(A) to CH(N) each of which corresponding to each of the reception channels CH1 to CH(n). In this case, an identical setting between one of the reception channels and one of the frequency channels in one of the tuner blocks 1_1 to 1_n should be found in all of the video receiving tuners 1 that are installed in the relay area. In other words, a pre-selected reception channel and a pre-selected frequency channel corresponding to the pre-selected reception channel of a tuner block in one video receiving tuner 1 should be identical with those of a tuner block in another video receiving tuner 1, and this applies to all tuner blocks in the same video receiving tuner 1. This makes it possible, as described before, to use one or more video receiving tuners 1 for relaying signals of different digital broadcasting channels in a small area.

Furthermore, as another way of application, the frequency channel of the control signal by which a user can select a reception channel and which the user transmits from the user's remote control or channel selector of the television receiver to the transmission/reception circuit block 9 through the antenna 7 is fixed for each of the users. In addition, the frequency channel of the transmission/reception circuit block 9 of each of the tuner blocks 1_1 to 1_n that are shown in FIG. 4 for receiving the control signal is preset for each of the users. In other words, for example, the tuner block 1_1 shown in FIG. 4 will be a tuner block preset exclusively for a user A, and the tuner block 1_2 is preset exclusively for a user B. In this application, even if there are a plurality of users in a narrower area such as in a house or a building, each one of the users can select and receive a desired broadcasting channel by transmitting a control signal to one of the tuner blocks 1_1 to 1_n that is assigned to that particular user.

Furthermore, in the two application examples relating to the video receiving tuner 1 shown in FIG. 4, as described above, it is also possible to cope with the video reception signals modulated in different modulation systems by using a plurality of tuner blocks 1_1 to 1_n. For example, the front-end block 3 of each of the tuner blocks 1_1 to 1_n receives one of the video reception signals of the digital BS broadcasting, the digital CS (Communication Satellite) broadcasting, the CATV broadcasting, and the digital terrestrial broadcasting, and selects one from among these broadcasting systems. The selected video reception signal is then demodulated and modulated by each of the modulation/demodulation circuit blocks 8a into a frequency of a particular frequency channel which is unique and different from each other in that video receiving tuner 1, and re-transmitted on that frequency channel. In this way, by using a single video receiving tuner 1, it is possible to realize a video receiving tuner 1 capable of demodulating signals of different digital broadcasting systems simultaneously.

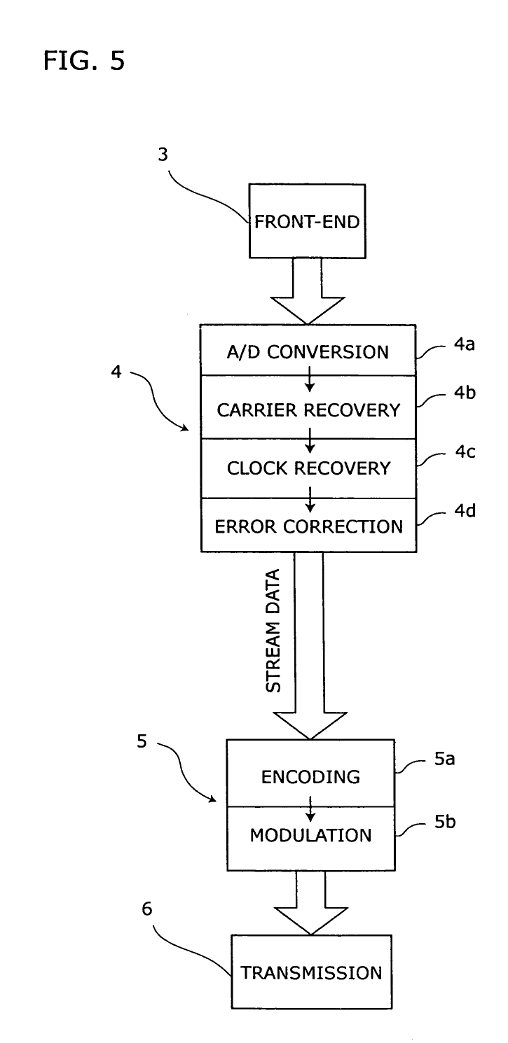

FIG. 5 is a block diagram showing a specific example of the video receiving tuner of the first embodiment shown in FIG. 1. In FIG. 5, such components as are found also in FIG. 1 are identified with the same reference numerals and descriptions thereof will not be repeated. The digital demodulation circuit block 4 comprises an A/D conversion block 4a for performing an A/D conversion so as to convert a digitally-modulated high frequency signal into a digital signal wave, a carrier recovery block 4b for recovering a carrier wave required for demodulation, a clock recovery block 4c for recovering a clock, and an error correction block 4d for performing error correction on the demodulated digital signal (stream data). The demodulated stream data is then fed to the re-modulation circuit block 5 comprising an encoding block 5a for encoding the digital signal and a modulation block 5b for modulating a carrier wave by the encoded digital signal. The digital signal is finally processed for transmission and transmitted by the transmission circuit block 6.

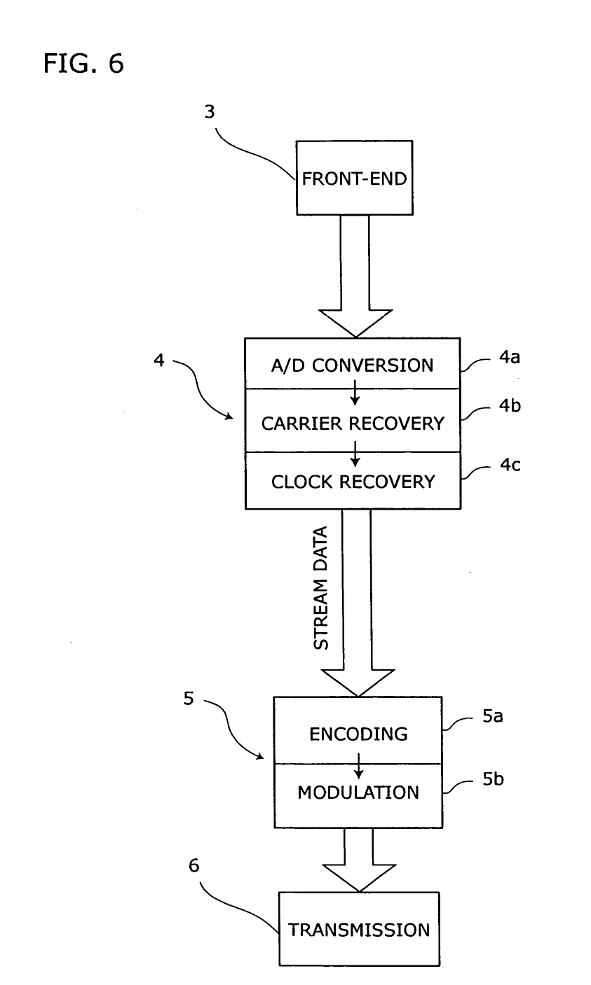

FIG. 6 is a block diagram showing another specific example of the video receiving tuner of the first embodiment shown in FIG. 1. In FIG. 6, such components as are found also in FIG. 1 and FIG. 5 are identified with the same reference numerals and descriptions thereof will not be repeated. In FIG. 6, the error correction block 4d shown in FIG. 5 is eliminated. This is because there is usually provided an error correction circuit in addition to a demodulation circuit and a decoding circuit in the television receiver that receives images transmitted by radio in digital form from the video receiving tuner 1 and, hence, the television receiver can perform error correction when the signal is demodulated. In this way, it is possible to eliminate the error correction block 4d from the video receiving tuner 1, miniaturize the video receiving tuner further, and reduce costs.

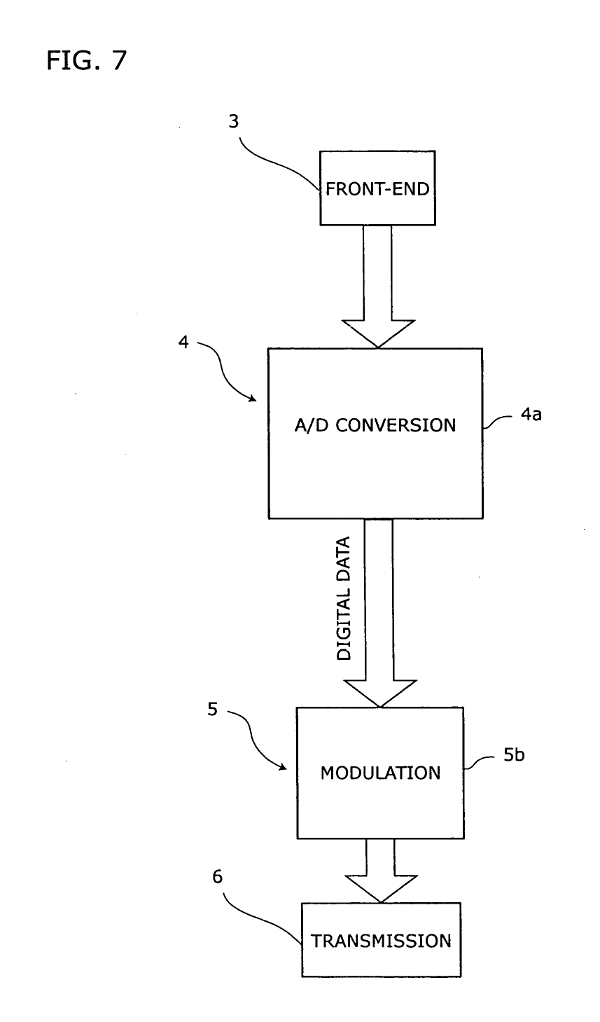

FIG. 7 is a block diagram showing still another specific example of the video receiving tuner of the first embodiment shown in FIG. 1. In FIG. 7, such components as are found also in FIG. 1 and FIG. 5 are identified with the same reference numerals and descriptions thereof will not be repeated. In FIG. 7, such blocks relating to demodulation as the carrier recovery block 4b, clock recovery block 4b, and the error correction block 4d shown in FIG. 5 are eliminated. The encoding block shown in FIG. 5 is also eliminated. With this configuration, it becomes possible, without demodulating the digital signal into the stream data, to directly modulate the digital signal obtained through A/D conversion in the A/D conversion block 4a into a so-called digital data communication form and transmit the resultant signal, provided that the television receiver at the receiving side is equipped with a demodulation circuit, a carrier recovery circuit, a clock recovery circuit, and an error correction circuit so as to convert the received digital data into the stream data. In this way, it is possible to miniaturize the video receiving tuner further and reduce costs.

It is possible to apply these examples to the video receiving tuner 1 of the second, third, and fourth embodiments of the invention by replacing the digital demodulation circuit block 4 shown in FIG. 4, FIG. 5, or FIG. 7 with the digital demodulation circuit block 4 shown in FIG. 2 or the digital demodulation circuit block of the modulation/demodulation circuit block 8a shown in FIG. 3 or FIG. 4; by replacing the re-modulation circuit block 5 shown in FIG. 5, FIG. 6, or FIG. 7 with the re-modulation/demodulation circuit block 8 shown in FIG. 2 or the re-modulation/demodulation circuit block of the modulation/demodulation circuit block 8a shown in FIG. 3 or FIG. 4; and by replacing the transmission circuit block 6 shown in FIG. 5, FIG. 6, or FIG. 7 with the transmission/reception circuit block 9 shown in FIG. 2 or the transmission/reception circuit block 9 shown in FIG. 3 or FIG. 4 respectively.

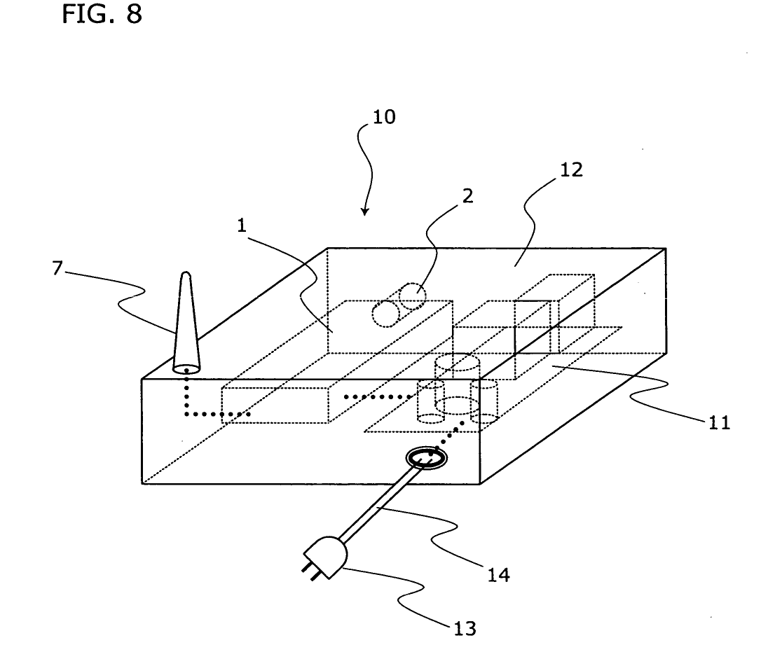

FIG. 8 is a perspective view showing a structure of the video receiving tuner embodying the invention. In FIG. 8, such components as are found also in FIG. 1 to FIG. 4 are identified with the same reference numerals. In FIG. 8, reference numeral 10 represents a video receiving tuner. The video receiving tuner 10 is configured in such a way that a video receiving tuner 1 and a power supply unit 11 for supplying power thereto are housed in a casing 12. An F-type plug 2 and an antenna 7 of the video receiving tuner 1 are fitted on a surface of the casing 12. A power cord 14 for supplying power from a commercial power source to the power supply unit 11 is extended from the power supply unit 11 to the outside of the casing 12 and fitted with a power plug 13 at the end of the power cord 14 for connecting to a power outlet.

In the video receiving tuner 10 configured in this way, the power fed from the commercial power source through the power outlet is supplied to the power supply unit 11 by way of the power plug 13 and the power cord 14. The power supply unit 11 generates power required for the operation of the video receiving tuner 1 and supplies the generated power to the video receiving tuner 1. The video receiving tuner 1, by receiving the video reception signals through the F-type plug 2 connected to an antenna terminal (not illustrated) provided in a room in which the video images are viewed and by receiving the power from the power supply unit 11 demodulates, as described earlier, a signal selected from among the video reception signals according to a selected channel into a digital signal, modulates again the demodulated digital signal into a radio signal, and transmits the radio signal through the antenna 7.

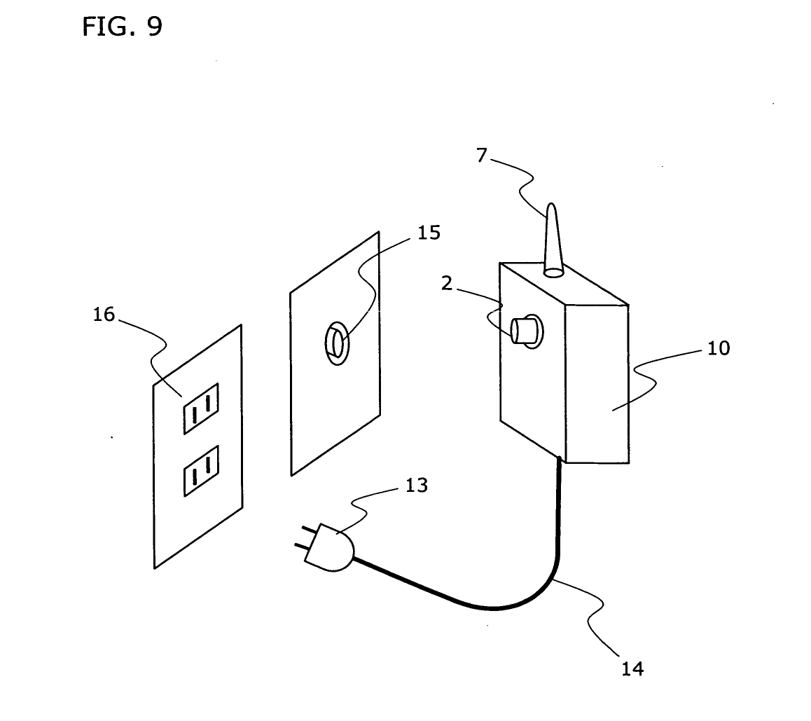

The video receiving tuner 10 configured in this way is a dedicated tuner device having a radio communication capability. For this reason, as shown in FIG. 8, the video receiving tuner 10 comprises only the video receiving tuner 1 and the power supply unit 11, and does not have any other additional functions. Therefore, the video receiving tuner 10 can be made small in size so that an area required for installation is reduced to a minimum. Because there are no other portions for additional functions and for controlling, it is also possible to shape the video receiving tuner 10 into such a type, as shown in FIG. 9, so as to be placed and used by directly connecting the F-type plug 2 to an antenna terminal 15 fitted in the wall.

FIG. 9 is a schematic diagram showing a relative location of the video receiving tuner embodying the invention when the tuner is used by being placed in such a way as to be directly connected to an antenna terminal fitted in the wall. In FIG. 9, such components as are found also in FIG. 8 are identified with the same reference numerals and descriptions thereof will not be repeated. In FIG. 9, reference numeral 15 is an antennal terminal fitted in the wall of a room for viewing the video images, and reference numeral 16 is a power outlet for supplying the commercial power and provided in proximity to the antenna terminal 15.

The video receiving tuner 10 shown in FIG. 9 is a type of video receiving tuner that is placed in close contact with a plane such as a wall. The F-type plug 2 is fixed on a surface of the casing so that the F-type plug 2 protrudes from the surface that comes in contact with the wall when the video receiving tuner 10 is installed. With this arrangement, a good fit and a direct connection are insured between the antennal terminal 15 and the F-type plug 2 so that the video receiving tuner 10 is placed in close contact with the wall. By connecting the power plug 13 to the power outlet 16 provided in a range within a reach of the power cord 14, the power is received and the video receiving tuner 10 can be operated. In addition to holding the video receiving tuner 10 on the wall to which the video receiving tuner 10 is laid by fitting the F-type plug 2 to the antenna terminal 15, it is also possible to fix the video receiving tuner 10 on the wall by arranging holes or the like through the casing and fixing the casing on the wall with bolts or the like.

In this arrangement, it is possible to connect the antenna terminal 15 and the F-type plug 2 together electrically without using an antenna cable such as a coaxial cable for transmitting the video reception signals. Furthermore, it is also possible to use the video receiving tuner 10 being suspended on the wall and, thereby, eliminate an area which otherwise will be occupied by the video receiving tuner 10 on the floor of the room.

Obviously, many modifications and variations of the present invention are possible in light of the above teachings. It is therefore to be understood that the present invention is not limited to the embodiments as described above and that within the scope of the appended claims, the invention may be practiced other than as specifically described.

As described, a video receiving tuner relating to the present invention comprises an input terminal for receiving video reception signals that are digitally modulated, a front-end block for amplifying the video reception signals fed thereto from the input terminal and selecting a signal of one channel as a selection signal from among the amplified video reception signals, a digital demodulation circuit block for demodulating the selection signal into a digital signal, a re-modulation circuit block for modulating a carrier wave having a predetermined frequency by the digital signal so as to produce a re-modulation signal, a transmission circuit block for processing the re-modulation signal fed thereto from the re-modulation circuit and outputting a resultant signal as a radio signal, an antenna for transmitting the radio signal, and a casing for enclosing the front-end block, the digital demodulation circuit block, the re-modulation circuit block, and the transmission circuit block. With this arrangement, an additional radio transmitting/receiving device for transmitting the digital signal to the television receiver is not required. Furthermore, because the digital signal is transmitted by radio and the wiring and routing of the lines required for the digital signal are minimized, it is possible to miniaturize the video receiving tuner that is compatible with the mobile and movable television receivers.

Moreover, a power supply unit for supplying power is housed in the same casing as the video receiving tuner, and an input terminal is provided on one surface of the casing so that, when said one surface of the casing is brought into contact with a plane surface on which an external antenna terminal for feeding the video reception signals is provided, a good fit between the external antenna terminal and the input terminal is insured. This arrangement makes it possible to eliminate an antenna cable required for connecting between the input terminal and the external antenna terminal to transmit the video reception signals, and miniaturize the video receiving tuner.

1. A video receiving tuner comprising:
an input terminal for receiving video reception signals that are digitally modulated;
a front-end block for amplifying the video reception signals fed thereto from the input terminal and selecting a signal of one channel as a selection signal from among the amplified video reception signals;
a digital demodulation circuit block for demodulating the selection signal into a digital signal;
a re-modulation circuit block for modulating a carrier wave having a predetermined frequency by the digital signal so as to produce a re-modulation signal;
a transmission circuit block for processing the re-modulation signal fed thereto from the re-modulation circuit and outputting a resultant signal as a radio signal;
an antenna for transmitting the radio signal; and
a casing for enclosing the front-end block, the digital demodulation circuit block, the re-modulation circuit block, and the transmission circuit block.

2. A video receiving tuner comprising:
an input terminal for receiving video reception signals that are digitally modulated;
a tuner block connected to the input terminal comprising:
a front-end block having an amplification block for amplifying the video reception signals fed thereto from the input terminal and a channel selection block for selecting, in accordance with a channel control signal obtained by demodulating a control signal which is externally given for selecting a desired channel, a signal of one channel as a selection signal from among the amplified video reception signals;
a digital demodulation circuit block for demodulating the selection signal into a digital signal;
a re-modulation/demodulation circuit block for modulating a carrier wave having a predetermined frequency by the digital signal so as to produce a re-modulation signal, and demodulating the control signal into the channel control signal so as to be fed to the channel selection block; and
a transmission/reception circuit block for processing the re-modulation signal fed thereto from the re-modulation circuit, outputting a resultant signal as a radio signal, and outputting the control signal fed thereto to the re-modulation/demodulation circuit block;
an antenna for transmitting the radio signal and receiving the control signal; and
a casing for enclosing the tuner block.

3. A video receiving tuner as claimed in claim 2,
wherein a plurality of said tuner blocks are enclosed in the casing.

4. A video receiving tuner as claimed in claim 3,
wherein a modulation system of the selection signal selected by at least one tuner block is different from a modulation system of the selection signal selected by another tuner block.

5. A video receiving tuner as claimed in claim 1,
wherein a modulation system used for producing the re-modulation signal is different from a modulation system used for producing the selection signal.

6. A video receiving tuner as claimed in claim 1,
wherein a frequency band of the carrier wave used for the re-modulation signal is a 2.4 GHz frequency band or a 5 GHz frequency band.

7. A video receiving tuner as claimed in claim 2,
wherein the digital demodulation circuit block and the re-modulation/demodulation circuit block are formed by a single integrated circuit.

8. A video receiving tuner as claimed in claim 2,
wherein a channel of the carrier wave of the predetermined frequency used by the re-modulation/demodulation circuit block to be modulated with the digital signal is associated in advance with the desired channel to be selected by the front-end block.

9. A video receiving tuner as claimed in claim 1,
wherein the video receiving tuner further comprises a power supply unit for supplying power thereto, and the power supply unit is housed in the casing.

10. A video receiving tuner as claimed in claim 9,
wherein the input terminal is provided on one surface of the casing so that, when said one surface of the casing is brought into contact with a plane surface on which an external antenna terminal for feeding the video reception signals is provided, a good fit between the external antenna terminal and the input terminal is insured so as to maintain said one surface of the casing in contact with the plane surface.

11. A video receiving tuner as claimed in claim 10,
wherein holding means is provided for holding the casing on the plane surface while a good fit is maintained between the external antenna terminal and the input terminal.

12. A video receiving tuner as claimed in claim 2,
wherein a modulation system used for producing the re-modulation signal is different from a modulation system used for producing the selection signal.

13. A video receiving tuner as claimed in claim 2,
wherein a frequency band of the carrier wave used for the re-modulation signal is a 2.4 GHz frequency band or a 5 GHz frequency band.

14. A video receiving tuner as claimed in claim 3,
wherein a channel of the carrier wave of the predetermined frequency used by the re-modulation/demodulation circuit block to be modulated with the digital signal is associated in advance with the desired channel to be selected by the front-end block.

15. A video receiving tuner as claimed in claim 2
wherein the video receiving tuner further comprises a power supply unit for supplying power thereto, and the power supply unit is housed in the casing.
